(19) United States
(12) Patent Application Publication
(10) Pub. No.: US 2004/0258355 A1
(43) Pub. Date: Dec. 23, 2004

(54) Micro-structure induced birefringent waveguiding devices and methods of making same

(76) Inventors: Jian Wang, Piscataway, NJ (US); Xuegong Deng, Piscataway, NJ (US)

Correspondence Address: REED SMITH LLP, 2500 ONE LIBERTY PLACE, 1650 MARKET STREET, PHILADELPHIA, PA, 19103, US

(21) Appl. No.: 10/463,256

(22) Filed: Jun. 17, 2003

(51) Int. Cl. G02B 6/34

(52) U.S. Cl. 385/37

(57) ABSTRACT

A birefringent device suitable for receiving electromagnetic radiation of at least one wavelength is disclosed. This device includes a waveguiding core suitable for transmitting the electromagnetic radiation. This device also includes a plurality of nanostructures defining a plurality of alternating regions of differing refractive indices, and positioned with respect to the waveguiding core to effect the polarization of the electromagnetic radiation traversing the waveguiding core.

### FIELD OF THE INVENTION

The present invention relates generally to optical components being suitable for producing birefringence thereby effecting polarization of propagating electromagnetic radiation.

### BACKGROUND OF THE INVENTION

Propagating electromagnetic radiation is composed of two orthogonally polarized components—known as the transverse electric and transverse magnetic fields. In many applications, it is necessary or desired to separately control the transverse electric (TE) or the transverse magnetic (TM) polarizations. Device performance which varies based on polarization state becomes important in optoelectronics allowing the possibility of multi-functioning devices. Birefringence is a property of a material to divide electromagnetic radiation into these two components, and may be found in materials which have two different indices of refraction, referred to as n⊥ and n_{∥} (or nₚ and nₛ), in different directions, often orthogonal, (i.e., light entering certain transparent materials, such as calcite, splits into two beams which travel at different speeds). Birefringence is also known as double refraction. Birefringence may serve to provide the capability of separating these two orthogonal polarizations, thereby allowing such devices to manipulate each polarization independently. For example, polarization may be used to provide add/drop capabilities, beamsplit incoming radiation, filter, etc. Birefringence is exhibited naturally in certain crystals such as hexagonal (such as calcite), tetragonal, and trigonal crystal classes generally characterized by having a unique axis of symmetry, called the optic axis, which imposes constraints upon the propagation of light beams within the crystal. Traditionally three materials are used for the production of polarizing components—calcite, crystal quartz and magnesium fluoride—each having significant limitations.

Generally, calcite is a widely preferred choice of material in birefringent applications, because of its birefringent qualities and spectral transmission characteristics, relative to other naturally occurring materials, though it is a fairly soft crystal and is easily scratched. Calcite, generally, has a birefringence of approximately 0.172.

Quartz, another often useful birefringent material, is available as either natural crystals or as synthetic boules. Natural and synthetic quartz both exhibit low wavelength cutoffs—natural quartz transmits from 220 nm, while synthetic transmits from 190 nm—and both transmit out to the infrared. Quartz is often desirably hard and strong thereby lending to the fabrication of very thin low order retardation plates. Unlike calcite or magnesium fluoride, quartz exhibits circular birefringence, and there is no unique direction (optic axis) down which ordinary and extraordinary beams propagate under one refractive index with the same velocity. Instead, the optic axis is the direction for which the two indices are closest: a beam propagates down it as two circularly polarized beams of opposite hand. This produces progressive optical rotation of an incident plane polarized beam; which effect may be put to use in rotators. Quartz has a birefringence on the order of 0.009.

Single crystal magnesium fluoride is another useful material for the production of polarizers, because of its wide spectral transmission. Single crystal magnesium fluoride has a birefringence of approximately 0.18.

However, materials found in nature, such as those discussed above, while possessing birefringent properties, actually possess, only a portion of the birefringence necessary or desirable for many applications. Alternatively, to use these materials to achieve a desired birefringence, large quantities of material may be required, taking up significant space. A need therefore exists for devices in which birefringent properties may be controlled and designed to achieve greater birefringence in a smaller area, thereby providing greater control of electromagnetic birefringent waves in a smaller area.

### SUMMARY OF THE INVENTION

A birefringent device suitable for receiving electromagnetic radiation of at least one wavelength is disclosed, including a waveguiding core suitable for transmitting the electromagnetic radiation, and a plurality of nanostructures defining a plurality of alternating regions of differing refractive indices, and positioned with respect to the waveguiding core to effect the polarization of at least one electromagnetic radiation traversing the waveguiding core.

### BRIEF DESCRIPTION OF THE FIGURES

Understanding of the present invention will be facilitated by consideration of the following detailed description of the preferred embodiments of the present invention taken in conjunction with the accompanying drawings, in which like numerals refer to like parts, and:

FIG. 1A illustrates a device according to an aspect of the present invention;

FIG. 1B shows a plot of the relationship between the refractive index and birefringence of the device of FIG. 1A according to an aspect of the present invention;

FIG. 2 illustrates a device incorporating strips and trenches according to an aspect of the present invention;

FIG. 3 illustrates a device incorporating strips and trenches according to an aspect of the present invention;

FIG. 4 illustrates a device incorporating pillars according to an aspect of the present invention;

FIG. 5 illustrates a device incorporating holes according to an aspect of the present invention;

FIG. 6 illustrates a device according to an aspect of the present as shown in FIG. 1A;

FIGS. 7A-E illustrate a construction of a Y-coupler waveguide incorporating the device of FIG. 1A according to an aspect of the present invention;

FIG. 8 illustrates a construction of a Y-coupler waveguide incorporating the device of FIG. 1A according to an aspect of the present invention;

FIGS. 9A and 9B illustrate a waveguide device incorporating the device of FIG. 1A suitable for state of polarization splitting devices according to an aspect of the present invention;

FIG. 10 illustrates a guiding waveguide device incorporating the device of FIG. 1A suitable for state of polarization splitting devices according to an aspect of the present invention;

FIG. 11 illustrates an arrayed waveguide grating according to an aspect of the present invention;

FIG. 12 illustrates a configuration of an arrayed waveguide grating similar to the grating shown in FIG. 11 according to an aspect of the present invention;

FIG. 13 illustrates an arrayed waveguide grating according to an aspect of the present invention;

FIG. 14 illustrates an arrayed waveguide grating according to an aspect of the present invention;

FIG. 15 illustrates an assembly drawing of making devices according to an aspect of the present invention;

FIG. 16 illustrates an assembly drawing of making devices according to an aspect of the present invention; and,

FIG. 17 illustrates an assembly drawing of making devices according to an aspect of the present invention.

### DETAILED DESCRIPTION OF THE PREFERRED EMBODIMENTS

It is to be understood that the figures and descriptions of the present invention have been simplified to illustrate elements that are relevant for a clear understanding of the present invention, while eliminating, for the purpose of clarity, many other elements found in typical photonic components and methods of manufacturing the same. Those of ordinary skill in the art will recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

In general, according to an aspect of the present invention, birefringence may be used to control the polarization of guided electromagnetic waves. Use of polarization to control electromagnetic waves may minimize many of the negative wavelength dependent effects often associated with wavelength control techniques, such as transmission roll-offs, non-uniformity of transmission, and transmission variation with respect to wavelength. Such birefringence may be induced using sub-operating wavelength optical structures, such as nanostructures or nanoelements, where the operating wavelength corresponds to the guided electromagnetic waves.

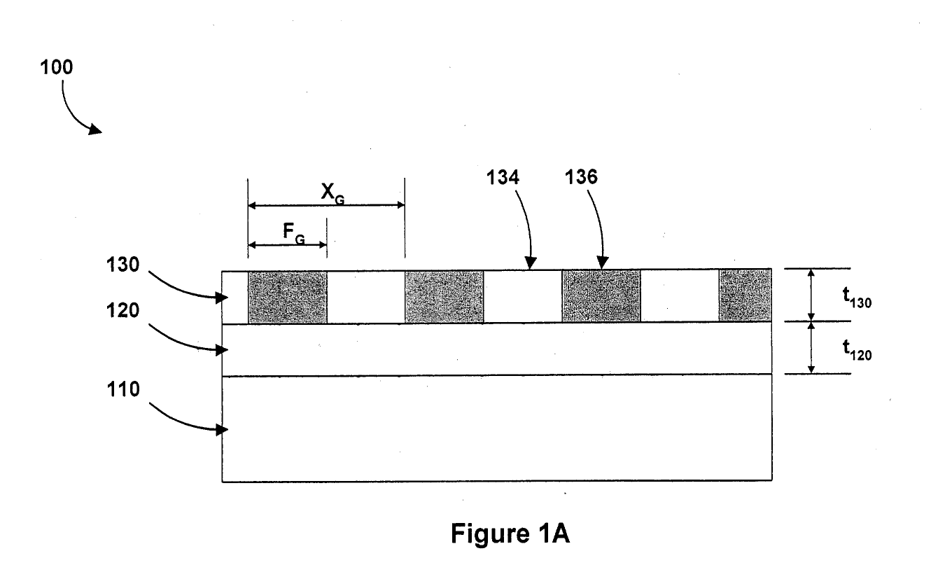

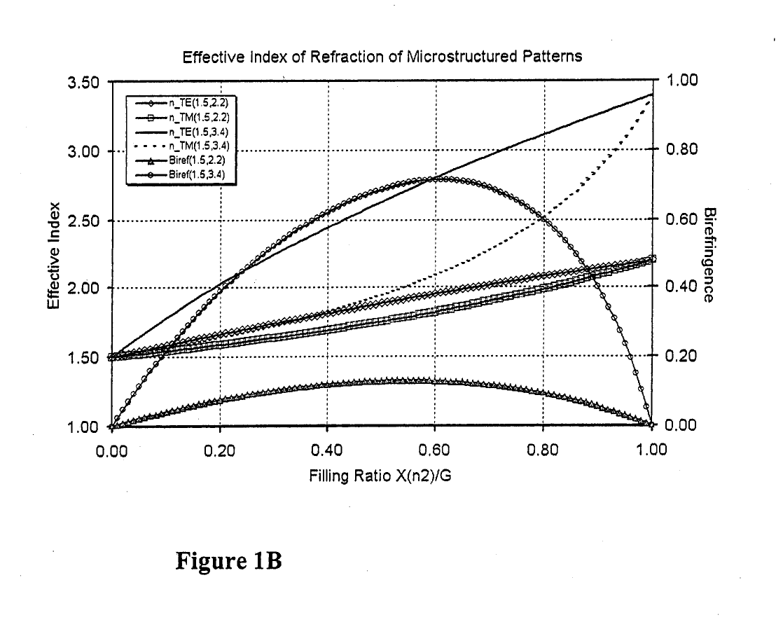

Referring now to FIG. 1A, there is shown a device 100 according to an aspect of the present invention. Device 100 may generally include a substrate 110 and a pattern of nanostructures 130 positioned substantially adjacent to substrate 130. Pattern of nanostructures 130 may include a plurality of index regions 134 and 136 of differing refractive indices positioned in an alternating manner. Device 100 may also include a layer 120 positioned between substrate 110 and pattern of nanostructures 130.

Substrate 110 may take the form of any traditional waveguiding material suitable for use in optics and known by those possessing ordinary skill in the pertinent arts. Suitable materials for substrate 110 may include materials commonly used in the art of grating or optic manufacturing, such as glass (like BK7, Quartz and Zerodur, for example), semiconductors, and polymers, by way of non-limiting example only.

Pattern of nanostructures 130, or nanoelement, sub-wavelength elements, may include multiple elements each of width F_{G} and height t₁₃₀. Further, the dimensions of the elements may vary or be chirped as will be understood by those possessing an ordinary skill in the pertinent arts. Pattern of nanostructures 130 may have a period of nanoelements, X_{G}. This period may also be varied or chirped. As may be seen in FIG. 1A, alternating refractive indices may be used. In FIG. 1A, for example, a higher index material 136, having a refractive index n_{F}, may be positioned substantially adjacent to a lower index material 134, having a refractive index n_{O}, creating an alternating regions of relatively high and low indices, respectfully. The filling ratio of pattern of nanostructures 130, denoted F_{G}/X_{G}, may be defined as the ratio of the width of the index area of the higher of the two refractive index elements within the period to the overall period. Filling ratio, F_{G}/X_{G}, may determine the operation wavelength of the device as defined by pattern of nanostructures 130, as would be evident to one possessing an ordinary skill in the pertinent arts. For completeness, there may be multiple materials 134, 136, each occupying a portion of overall period X_{G}. This portion may be functionally represented as:

$${f}_{k} = \frac{{F}_{{G}_{k}}}{{X}_{G}} ; for k = 1 , 2 , 3 , … , M ; and {\sum }_{k = 1}^{M} {f}_{k} = 1$$

where the characteristic dimension X_{G} is much less than the operating wavelength of the device, such as, for example, an operating wavelength λ=1550 nm and X_{G} on the order of 10 to 1000 nm. The effective refractive index may be approximated by the following functions:

$${n}_{TE} = {( {\sum }_{k = 1}^{M} {f}_{k} {n}_{x}^{- 2} )}^{- \frac{1}{2}} and {n}_{TM} = {( {\sum }_{k = 1}^{M} {f}_{k} {n}_{y}^{2} )}^{\frac{1}{2}}$$

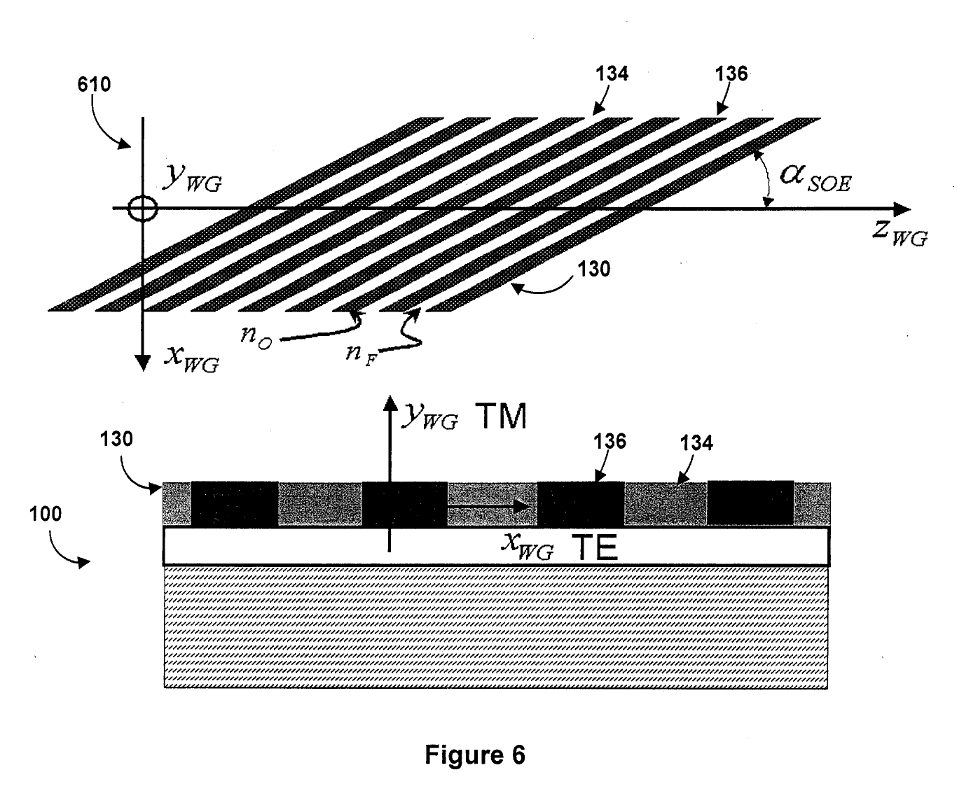

for α_{SOE}=λ/2 according to the coordinates described hereinbelow with respect to FIG. 6.

Pattern of nanostructures 130 may be grown or deposited on substrate 110. Pattern of nanostructures 130 may be formed into or onto substrate 110 using any suitable replicating process, such as a lithographic process. For example, nanoimprint lithography consistent with that disclosed in U.S. Pat. No. 5,772,905, entitled NANOIMPRINT LITHOGRAPHY, the entire disclosure of which is hereby incorporated by reference as if being set forth in its entirety herein, may be effectively used. Therein is taught a lithographic method for creating nanostructures, such as sub 25 nm elements, patterned in a thin film coated on a surface. For purposes of completeness and in summary only, a mold having at least one protruding feature may be pressed into a thin film applied to substrate 110. The at least one protruding feature in the mold creates at least one corresponding recess in the thin film. After replicating, the mold may be removed from the film, and the thin film processed such that the thin film in the at least one recess may be removed, thereby exposing a mask that may be used to create an underlying pattern or set of devices. Thus, the patterns in the mold are replicated in the thin film, and then the patterns replicated into the thin film are transferred into the substrate 110 using a method known to those possessing an ordinary skill in the pertinent arts, such as reactive ion etching (RIE) or plasma etching, for example. Of course, any suitable method for forming a suitable structure into or onto an operable surface of substrate 110, for example, may be utilized though, such as photolithography, holographic lithography, e-beam lithography, by way of non-limiting example only. Substrate 110 may take the form of silicon dioxide while a thin film of silicon forms pattern of nanostructures 130, for example.

Layer 120 may be included within device 100. This layer, if present, may take the form of insulator, semiconductor, metallic, or polymeric material thin films, including glasses, metal oxides, fluorides, amorphous silicon, silicon nitrides, oxynitrides, and polymers, for example. Layer 120 may be designed, for example, as is known to those possessing an ordinary skill in the pertinent arts, to be an etch protective layer or etch stop, such that when etching pattern of nanostructures into layer 130, the protective layer has a slow etch rate. This slow etch rate may create a buffer to prevent over etching. For example, if the etch rate of layer 130 is designed to be 5˜10 nm per minute and the etch rate of layer 120 is less than 0.5˜2 nm per minute, layer 120 etching at such a lower rate lessens the need to be exact in the etch time of layer 130. Layer 130 may be etched through and the much slower etch rate of layer 120 provides a protective padding.

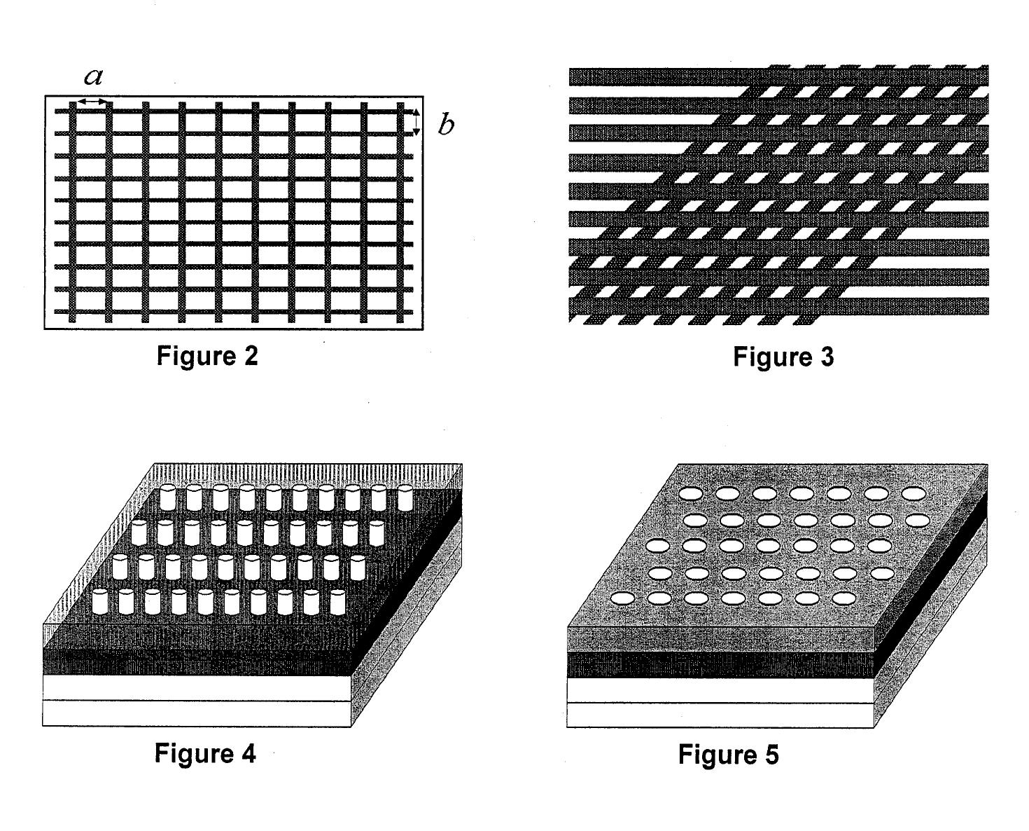

According to an aspect of the present invention, an underlying one-dimensional (1-D) pattern of nanostructures 130, preferably formed of materials of high contrast refractive index, having high and low refractive index areas with distinct differences in refractive index, may be so formed on substrate 110. Referring now also to FIGS. 2-5, according to an aspect of the present invention, two-dimensional (2-D) pattern of nanostructures 130, preferably formed of materials of high contrast refractive index may be so formed on substrate 110.

As will be recognized by those possessing ordinary skill in the pertinent arts, various patterns may be replicated in such a manner onto or into substrate 110. Such patterns may take the form of strips (shown in FIGS. 2 and 3), trenches (also shown in FIGS. 2 and 3), pillars (shown in FIG. 4), or holes (shown in FIG. 5), for example, all of which may have a common period or not, and may be of various heights and widths. Strips may take the form of rectangular grooves, for example, or alternatively triangular or semicircular grooves, by way of non-limiting example. Similarly pillars, basically the inverse of holes, may be patterned. Such pillars may be patterned with a common period in either axis or alternatively by varying the period in one or both axes. The pillars may be shaped in the form of, for example, elevated steps, rounded semi-circles, or triangles. The pillars may also be shaped with one conic in one axis and another conic in another, for example.

Referring now to FIG. 1 B, there is shown a plot of a relationship between the refractive index and birefringence of the device of FIG. 1A according to an aspect of the present invention. As may be apparent from the plot, the two indices of refraction, TE and TM, are plotted against the filling ratio (F_{G}/X_{G}). Also shown is the birefringence of the device of FIG. 1A B≡Biref (n₁, n₂) plotted against the filling ratio (F_{G}/X_{G}). This plot was calculated based on a high contrast index of refraction wherein n_{F}=2.2 and n_{O}=1.5, as n_{F} and n_{O} are discussed hereinabove, and different filling ratios based on F_{G}/X_{G}. As may be seen in FIG. 1B, birefringence above 0.10 may be achieved utilizing the device of FIG. 1A. As would be evident to one possessing an ordinary skill in the pertinent arts, this birefringence may be explained using an approximate theory, such as effective media theory (EMT), for example, or calculated from electromagnetic theories, such as rigorous wave methods, for example. The curves of FIG. 1B are calculated using the equations discussed hereinabove with respect to the filling ratio discussion. In this calculation a zero-order approximation is utilized as derived from EMT. As may be seen in FIG. 1B, the curves demonstrate the birefringence accessible through proper material combinations and structure engineering. By comparison, as is known to one possessing an ordinary skill in the pertinent arts, quartz, for example, has a birefringence approximately equal to 0.009. Therefore, to achieve the same level of birefringence quartz would need to be approximately 10 times thicker than the device of FIG. 1A.

Referring now to FIG. 6, there is shown a device according to an aspect of the present invention shown in FIG. 1A. As may be seen in FIG. 6, there is shown a cross sectional view of device 100 and a theoretical coordinate system 610 overlaid therewith. Using coordinate system 610 oriented for FIG. 6, the birefringence of device 100 created by pattern of nanostructures 130 may be explained. The relationship between the axes of coordinate system 610 and pattern of nanostructures 130 including high index regions 136 of refractive index n_{F} and low index regions 134 of refractive index n_{O} creates a scheme for analyzing the birefringence of device 100. For example, there may be an angular offset between the axes of the coordinate system 610 and pattern of nanostructures 130 including high index regions 136 and low index regions 134 defining angle α_{SOE}. The equation principally governing the birefringence is:

$${ϵ}_{ij} ≡ [ {n}_{ij}^{2} ] = [ \begin{matrix}{cos}^{2} ( {α}_{SOE} ) {ϵ}_{Z} + {sin}^{2} ( {α}_{SOE} ) {ϵ}_{X} & 0 & \frac{1}{2} sin ( 2 {α}_{SOE} ) ( {ϵ}_{X} - {ϵ}_{Z} ) \\ 0 & {ϵ}_{Y} & 0 \\ \frac{1}{2} sin ( 2 {α}_{SOE} ) ( {ϵ}_{X} - {ϵ}_{Z} ) & 0 & {cos}^{2} ( {α}_{SOE} ) {ϵ}_{X} + {sin}^{2} ( {α}_{SOE} ) {ϵ}_{Z}\end{matrix} ] \\ i , j = x , y , z \qquad ( 1 )$$

where εₓ≈n_{TE}², ε_{y}≈n_{TM}², and ε_{Z} may depend on the original structure induced birefringence. Additionally, nᵢⱼ may be dependent on the rotation angle of the birefringence structure relative to the waveguide direction depicted in FIG. 6 as α_{SOE}. As may be apparent to those possessing an ordinary skill in the pertinent arts linearly polarized energy propagating through the waveguide may be rotated, exhibit periodic conversions from TE to TM, and vice versa. The period of such a conversion is called polarization conversion beat-length, L_{PCB}. The polarization beat-length describes the degree of birefringence and it is defined by:

$${L}_{PCB} = \frac{λ}{{n}_{TE}^{( WG )} - {n}_{TM}^{( WG )}}$$

where λ is the wavelength propagating or the center wavelength propagating through device being analyzed and n_{TE}^{(WG)} and n_{TM}^{(WG)} are the effective indices of the TE and TM waveguide modes. Thus, for example, using the values for generating FIG. 1B wherein n_{F}=2.2 and n_{O}=1.5, as n_{F} and n_{O} are discussed hereinabove, and a wavelength equal to 1.5 μm, L_{PCB} may be engineered from tens of micrometers to centimeters.

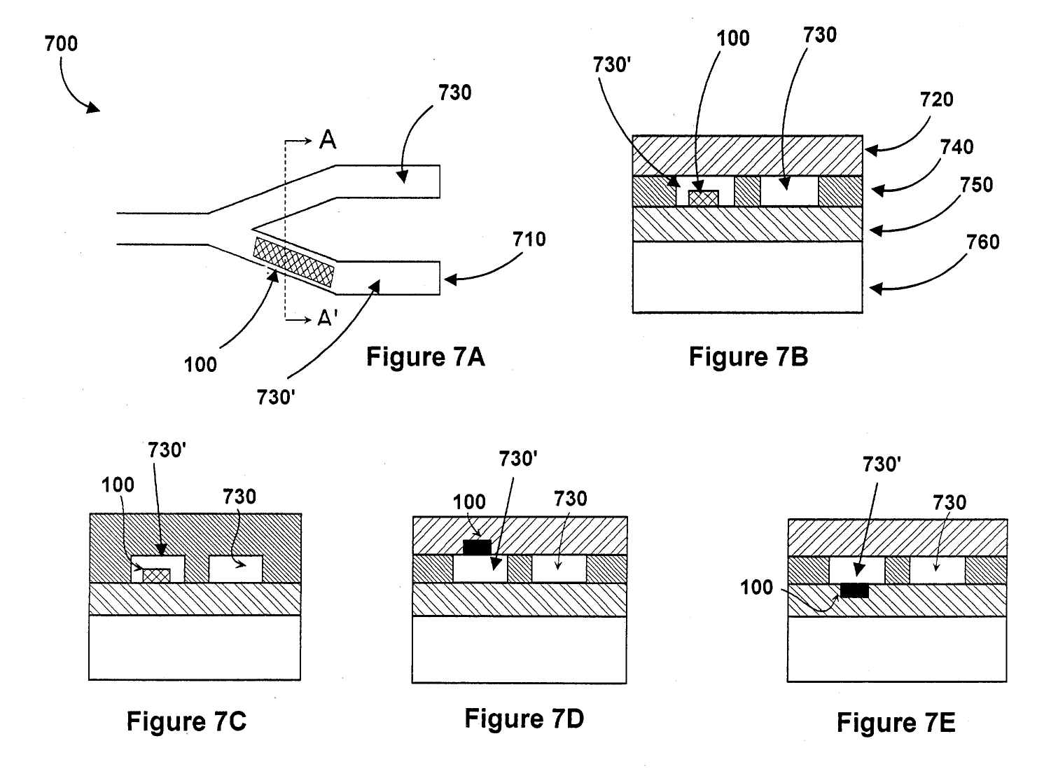

Referring now to FIGS. 7A-E and 8A-B, there are shown constructions of a waveguide device 700 incorporating device 100 into a Y-coupler according to an aspect of the present invention. Referring to FIG. 7A, device 100 may be positioned within waveguide device 700 to minimize dependence on the rotation angle of the birefringence structure relative to the waveguide direction depicted in FIG. 6 as α_{SOE}, for example. Alternatively, this dependence may be used in some applications to select portions of a propagating electromagnetic wave.

For example, for polarization beamsplitting applications, α_{SOE} may be minimized so as to facilitate such aligning to orient either the TE or TM to the orientation of pattern of nanostructures 130 thereby reducing any cross-coupling between TE and TM. Accordingly, device 100 may be oriented within waveguide device 700 such that propagation direction is substantially parallel to features of device 100. Device 100 functions to index load waveguide core portion as compared to waveguide core 730. Index loading, as may be known to those possessing an ordinary skill in the pertinent arts, may be defined as creating a change in the refractive index of a propagating medium, for example, a waveguide core 730. While the propagating medium may have a refractive index itself, placing device 100 proximately to propagating medium may cause a change in this refractive index, associated with device 100 and the placement of device 100, thereby index loading the propagating medium.

As may be seen in FIG. 7B-7D, waveguiding device 700 may include an upper cladding 720, a waveguide core 730 within a central cladding 740, and a lower cladding 750. Upper cladding 720, central cladding 740 and lower cladding 750 may substantially take the form of thin films made of silicon dioxide, silicon oxynitride, semiconductors, glass, or polymers and waveguide core 730 may substantially take the form of confined regions made of silicon dioxide, silicon oxynitride, semiconductors, glass or polymers of higher optical refractive indices with respect to some or all of upper cladding 720, central cladding 740, and lower cladding 750. While upper cladding 720, central cladding 740 and lower cladding 750 may substantially take the form of the same substance, it is not necessary and one or more of these claddings may be a separately selected material from the possible materials as described hereinabove.

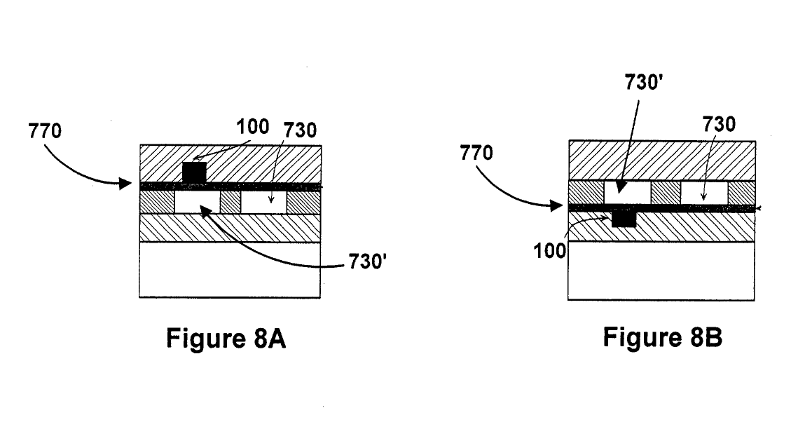

For example, waveguide device 700 may include a central cladding 740 with at least one waveguide core 730 included therein. Lower cladding 750 may be disposed substantially adjacent to central cladding 740. Upper cladding 720 may be disposed substantially adjacent to central cladding 740 distal to lower cladding 750. Additionally, a substrate 760, which may substantially take the form of silicon or other semiconductors, glass, or polymeric wafer in various shapes, may be provided as shown in FIGS. 7A-E. Substrate 760 may be disposed substantially adjacent to lower cladding 750 and located distal to central cladding 740. As may be further seen in FIGS. 8A-B, waveguide device 700 may also include a residual layer 770 disposed substantially adjacent to central cladding 740. Residual layer 770 may have been used as an etch stop, for example. Residual layer 770 may substantially take the form of thin films substantially made of silicon dioxide, silicon oxynitride, amorphous silicon, polymer, glass, or active semiconductors for the operating wavelength.

As may be seen from FIGS. 7A-E and 8A-B, device 100 may be incorporated within waveguide device 700 at various locations. Each location for device 100 is proximately located with respect to waveguide core 730, as shown in both FIGS. 7A-E and 8A-B, for example, so as to effect index loading of portion 730 as would be understood to those possessing an ordinary skill in the pertinent arts. For example, as shown in FIGS. 8A-B, device 100 may be incorporated within upper cladding 720 thereby index loading waveguide core 730, within lower cladding 750 thereby, also, index loading waveguide core 730, or within central cladding 740, for example. Device 100 may also be separated from waveguide core 730 by another layer, such as residual layer 770, for example, wherein such separation and other layer do not entirely prevent index loading of waveguide core 730. Of course, device 100 may be positioned at any suitable location for index loading portion 730, as FIGS. 7A-7E are by way of non-limiting example only.

Operationally, electromagnetic radiation propagating in a waveguide encountering Y-coupler 710 including one branch incorporating device 100 may cause TE and TM modes of the propagating electromagnetic radiation to couple into different arms 730′, 730 of Y coupler 710 as a result of the index loading associated with device 100, as discussed hereinabove. This operation is associated with the birefringence of device 100. As is known to those possessing an ordinary skill in the pertinent arts, a single polarization will be transmitted by a birefringent medium traversed by orthogonal polarizations. As random polarization light traverses a waveguide and impinges upon a portion of the waveguide 710 associated with device 100 the birefringence associated with device 100 causes a single polarization to be transmitted through waveguide 710. As a result the second branch of the Y-coupler 730 will transmit the orthogonal polarization to that transmitted in the first branch.

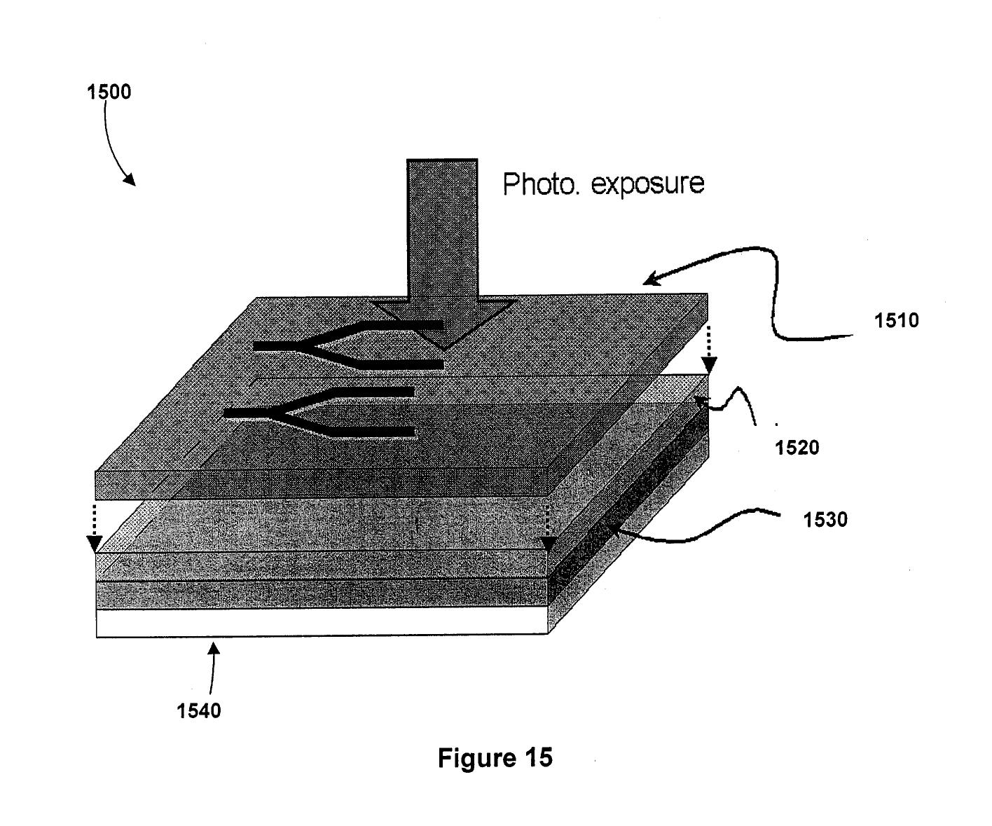

An assembly drawing for making devices 100 and waveguide devices 700 may be seen in FIGS. 15-17. Referring now to FIG. 15, there is shown an assembly drawing 1500 of assembling device 100 and incorporating device 100 into waveguide device 700 for example.

A substrate 1540 may be polished to optical flatness. Substrate 1540 may be a semiconductor, including Si, or glass, including BK7, Pyrex, fused silica, and Zerodur. Substrate 1540 may be cleaned by a technique known to those possessing an ordinary skill in the pertinent arts, such as standard RCA for silicon, including other chemical solutions, ultrasonic bath, brushing, for example.

After substrate 1540 is prepared, such as described hereinabove, subsequent layers of materials may be added, which may include cladding 1530 and core 1520. Cladding 1530 may include doped silicon dioxides or silicon oxynitride. Core 1520 may include silicon oxides doped with a different ion or to different levels. These layers 1530, 1520 may be added or deposited in a way known to one possessing an ordinary skill in the pertinent arts such as by: physical vapor deposition including thermal evaporation, e-beam deposition, and sputtering; chemical vapor deposition including CVD, LPCVD, PECVD, and APCVD; reactive sputtering; and flame hydrolysis deposition (FHD). Assembly 1500 may include use of a waveguide mask 1510 overlying surface 1520 atop a stack of layers including cladding 1530 and substrate 1540. In assembling devices 100 and waveguide devices 700, surface 1520, cladding 1530, and substrate 1540 are formed in a stack of co-planar layers.

Surface 1520 may then be overlayed with waveguide mask 1510 and photo exposed. Transfer of the patterned mask may be accomplished using techniques known to those possessing an ordinary skill in the pertinent arts. For completeness a photosensitive polymer, such as a resist, may be applied with a defined thickness. This layer may then be baked. Photolithography may be used to transfer the desired waveguide patterns into the resist. This photolithography may be performed using either a positive or negative patterned mask depending on the resist used.

Mask 1510 may then be removed and exposed surface 1520 etched to form a waveguide core. After transfer of the patterns, the resist may be used as an etching mask to further transfer the pattern into core 1520 or cladding 1530, as desired.

A lift-off step may then be performed utilizing such metals as Cr, Ti, Ni, or Al. After transfer any remaining resist may be stripped off. Additional cladding may be formed adjacent to the formed waveguide core distal to cladding 1530. Cladding 1530 may then be disposed substantially adjacent to etched layers 1520 by means known to those possessing an ordinary skill in the pertinent arts, such as PVD, CVD, or FHD, for example. The waveguide core may be formed through other methods, for example, ion exchange in glass substrate, inter-diffusion of titanium in LiNbO₃ substrates or epitaxy layers, and ion implantation.

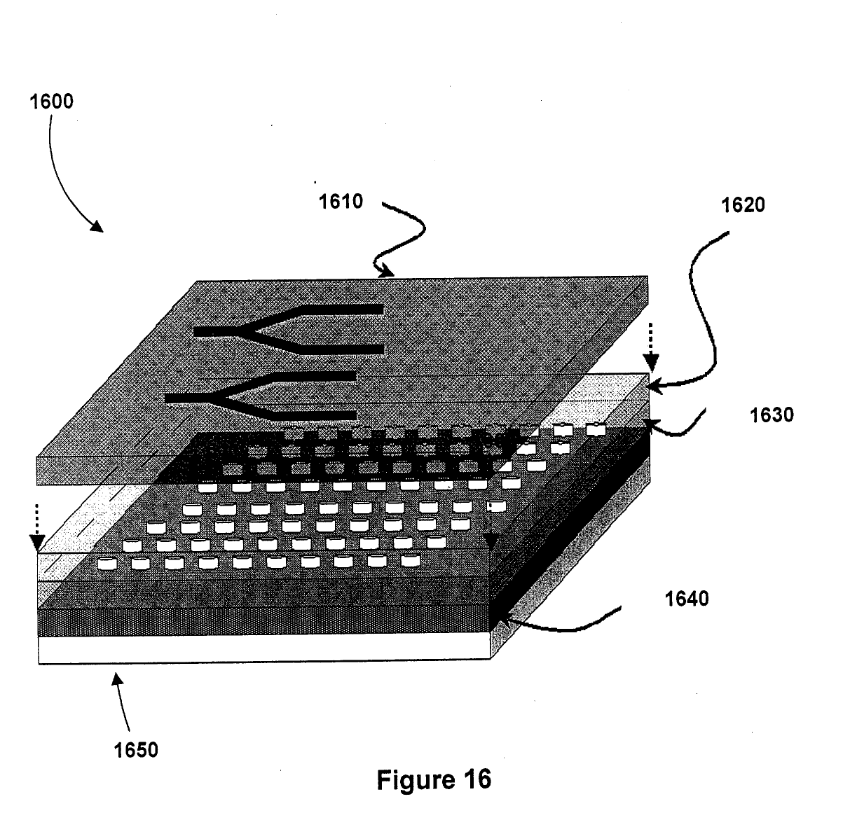

Referring now to FIG. 16, there is shown a drawing 1600 of assembling device 100 and incorporating device 100 into waveguiding device 700 for example. Drawing 1600 may include using a waveguide mask 1610 coupled to a photoresist or polymer 1620 such that the layer 1620 may accept features of mask 1610. Substantially adjacent to layer 1620 may be a patterned layer 1630 stacked on a cladding 1640 and a substrate 1650. In assembling devices 100 and waveguide devices 700, surface 1620, patterned layer 1630, cladding 1640, and substrate 1650 are formed in a stack of co-planar layers. Substrate 1650 may be cleaned, as is known to those possessing an ordinary skill in the pertinent arts, and deposited on substrate 760. Cladding 1640 may be deposited on substrate 1650. Cladding 1640 may be a silicon oxynitride of the form SiOₓN_{y}, for example, having a refractive index nₒ. A photoresist 1620 capable of receiving nanoimprinting, such as a polymer or photoresist, may be deposited on cladding 1640. The plurality of structures may be transferred into photoresist 1620 using techniques discussed hereinabove. After transferring the pattern, a filling material, such as, polymer TEOS SiO₂, PSG or BSG glasses having a refractive index nᵣ, may be deposited thereby substantially filling the patterned layer. Subsequently, a planarization may be performed, as is known to those possessing an ordinary skill in the pertinent arts. Structure 100 may then be formed using techniques known to those possessing an ordinary skill in the art, such as, photolithography, for example. After structure 100 is formed waveguiding core 1630 may be deposited onto structure 100, and upper cladding may be formed on waveguiding core 1630 and structure 100.

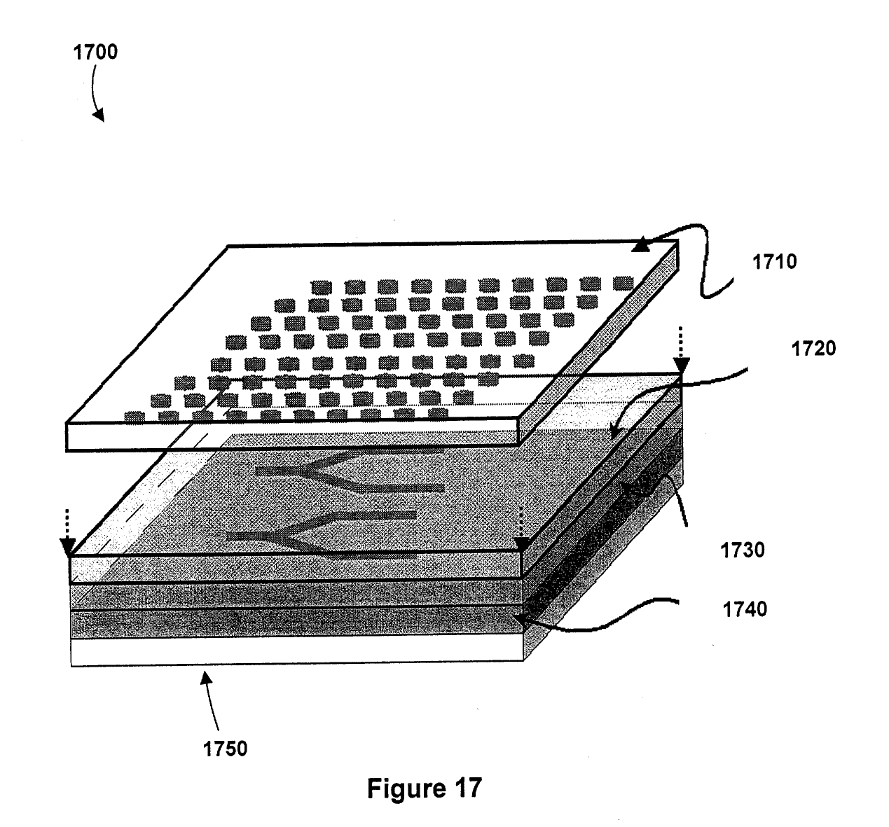

Referring now to FIG. 17, there is shown a drawing 1700 of assembling device 100 and incorporating device 100 into waveguiding device 700 for example. Drawing 1700 may include using a imprint mold 1710 arranged substantially adjacent to a photoresist or polymer layer 1720 such that layer 1720 may accept features of imprint mold 1710. Additionally, polymer layer 1720 may be arranged substantially adjacent to a waveguide core 1730, substantially adjacent to a cladding 1740, and cladding 1740 is substantially adjacent to substrate 1750.

A mold 1710 including features, such as micro-patterns, for example, may be transferred to layer 1720 through a method known to those possessing an ordinary skill in the pertinent arts, such as nanoimprinting lithography. Mold 1710 may include alignment features, as is known to those possessing an ordinary skill in the pertinent arts, used in photolithography.

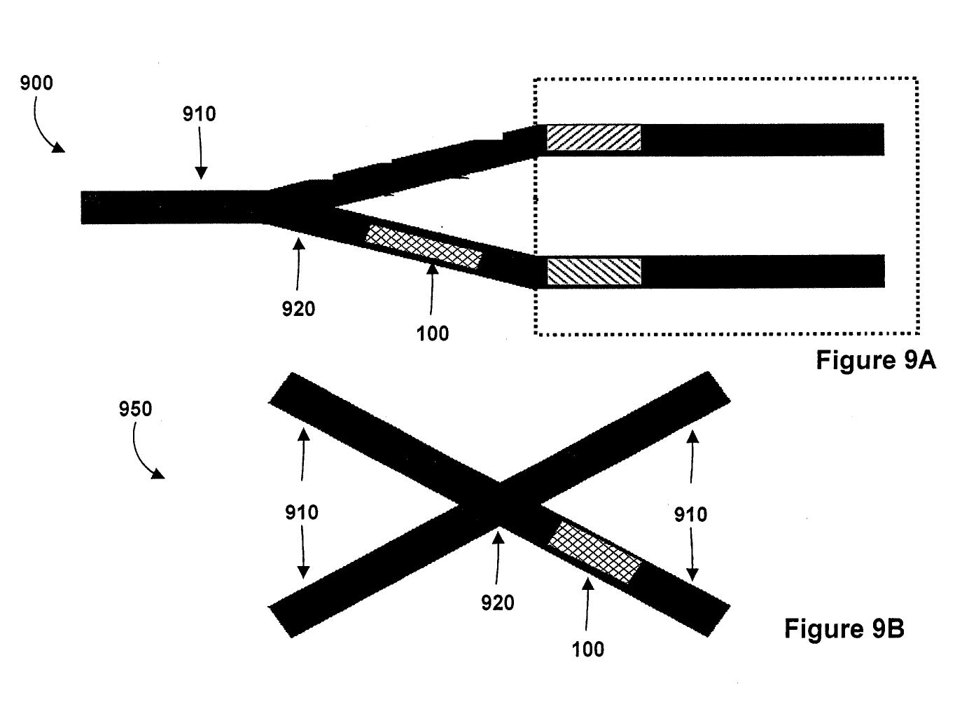

Referring now to FIGS. 9A and 9B, there are shown waveguide devices 900, 950 respectively, incorporating device 100 suitable for state of polarization splitting devices according to an aspect of the present invention. As may be seen in FIGS. 9A and 9B, a Y-junction 900 or a X-junction 950 may be employed. In either configuration, electromagnetic radiation propagating in a waveguide 910 encountering a junction 920 including one arm incorporating device 100 may cause TE and TM modes to couple into different arms across the junction as a result of the difference in refractive index associated with device 100, as discussed hereinabove.

As is known to those possessing an ordinary skill in the pertinent arts, after polarization splitting, propagating radiation in one portion of waveguide device may be rotated with respect the radiation propagating in another portion of waveguide device. According to an aspect of the present invention, this rotation may be achieved by utilizing different nanostructure patterns within pattern of nanostructures 130 in device 100. This rotation may be suitable for performing various processing on each of the arms of the branch. For example, this processing may include amplification of propagating radiation in one portion of waveguide and comparison with the radiation propagating in another portion, beamsplitting a portion of the propagating electromagnetic radiation to be used or monitored, and add/drop filtering.

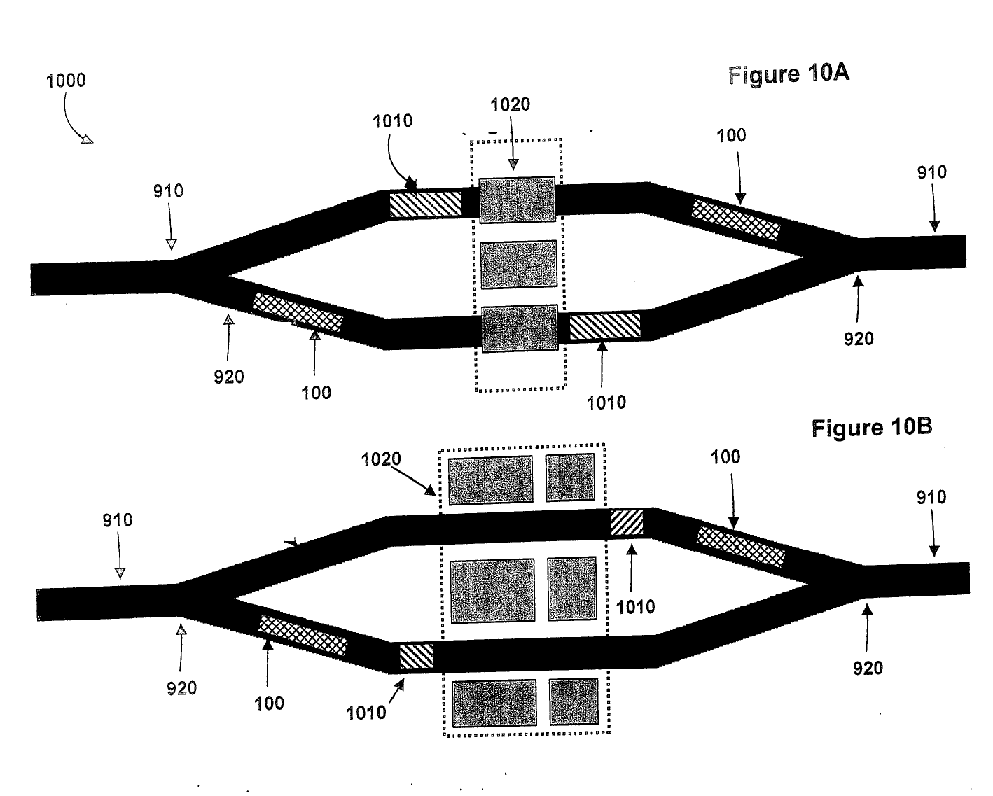

Referring now to FIGS. 10A-B, there is shown a guiding waveguide device 1000 incorporating device 100 suitable for utilizing state of polarization splitting processing according to an aspect of the present invention. Guiding waveguide device 1000 may include waveguide 910, such that electromagnetic radiation propagating in a waveguide 910 encountering a junction 920 including one arm incorporating device 100 may cause TE and TM modes to couple into different arms across the junction as a result of the difference in refractive index associated with device 100, as discussed hereinabove. Each of TE and TM propagate in the respective arms. In one or both of the respective arms, another device 1010 may be incorporated in order to provide a rotation of the polarization state with respect to the polarization incident on device 1010. Processing 1020 may then occur utilizing one or more arms of the waveguide device 1000. After processing another device 1010 may be incorporated in order to provide a rotation of the polarization state with respect to the polarization incident on device 1010. The Y-branch coupler may have its branches reunited which may provide the electromagnetic radiation, which may be similar to the electromagnetic radiation incident on device 1000, out of the device via waveguide 910. Processing 1020 may effect the electromagnetic radiation such that the electromagnetic radiation traversing the reunited branch is different than that incident on device 1000.

As is shown in FIGS. 10A-B, waveguide device 1000 may incorporate phase control such as modulation using suitable methods known to those possessing an ordinary skill in the pertinent arts. One example of such a modulation and control technique may be to incorporate as travelling wave electrode (TWE). Control techniques may also include switching, polarization control, and beam splitter combiners. For example, control techniques consistent with that disclosed in U.S. Pat. No. 5,091,981, entitled TRAVELING WAVE OPTICAL MODULATOR, the entire disclosure of which is hereby incorporated by reference as if being set forth in its entirety herein may be effectively used.

Waveguide device 1000 may be used as a polarization insensitive optical modulator. Operationally, optical signals traversing waveguide device 1000 may be split into two arms of Y-junction 920 depending on their polarization. Second section of microstructure 1010 rotates one of the polarization states thereby substantially aligning with the signal of opposite polarization split to the other arm. Electrical modulation signals, as would be evident to one possessing an ordinary skill in the pertinent arts, may be applied to the electrodes 1020. One optical signal may be rotated by 1010, thereby creating one arm with one polarization and another arm with a substantially orthogonal polarization. The two signal with different polarizations may be combined by traversing a second polarization combiner 920. Other techniques may be useful, as would be evident to those possessing an ordinary skill in the pertinent arts, such as domain inversion, and employing more than one set of electrodes, for example.

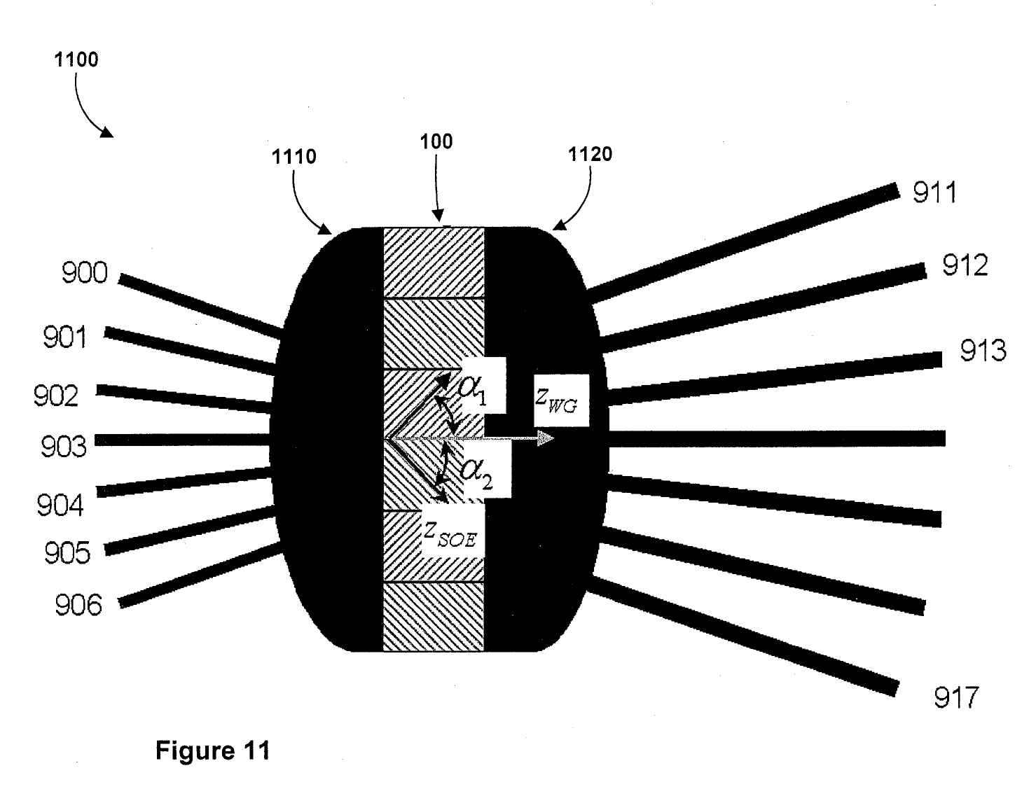

Referring now to FIG. 11, there is shown an arrayed waveguide grating (AWG) structure 1100 according to an aspect of the present invention. AWGs are known generally to those possessing an ordinary skill in the art. For example, AWGs consistent with that disclosed in U.S. Pat. No. 5,617,234, entitled MULTIWAVELENGTH SIMULTANEOUS MONITORING CIRCUIT EMPLOYING ARRAYED-WAVEGUIDE GRATING, the entire disclosure of which is hereby incorporated by reference as if being set forth in its entirety herein may be effectively used. An AWG according to an aspect of the present invention may be suitable for use as a wavelength division multiplexer/demultiplexer, a wavelength filter, an add/drop filter, or a switch by way of non-limiting example only. As shown, AWG 1100 may include input channels 900-906, output channels 911-917, a plurality of devices 100, an input region 1110, and an output region 1120. AWG 1100 may be configured with input channels 900-906 optically coupled to input region 1110 and output region 1120 optically coupled to output channels 911-917 with a myriad of devices 100 optically located between input region 1110 and output region 1120. AWG 1100 configured as shown in FIG. 11 may provide a low polarization dependent loss and a low polarization dependent wavelength shift. In the state of polarization and control region, a single device 100 may be used. Alternatively, multiple devices 100 may be used. Also, as described hereinabove, each of the multiple devices 100 in state of polarization and control region may have differing periods. By utilizing among other things, different periods and a plurality of devices 100, the function of the AWG may be manipulated. As discussed in conjunction with FIG. 6, orienting device 100 at an angle with respect to a pattern of energy propagation may function to modify the propagation characteristics of device 100 with respect to energy propagation on such an AWG. In this way by varying the angle that individual devices 100 are aligned in AWG 1100 with respect to input and output polarization splitting of each electromagnetic propagation on individual channels may be controlled. This angle, which relates to the alignment of individual devices 100, may be seen in FIG. 11, as angles α₁, α₂, Z_{WG} and Z_{SOE}. For example, by way on non-limiting example only, α₁=−α₂=22.5 degrees. Operationally, depending on the particular function of arrayed waveguide grating 1100, light incident on state of polarization and control region from at least one of the input channels 900-906 may be substantially coupled into a desired output channel 911-917. For example, if arrayed waveguide grating 1100 is designed to operate as a wavelength filter, each output channel 911-917 may receive a select wavelength band or polarization band. Similarly, for example, if arrayed waveguide grating 1100 is configured as a wavelength division multiplexer, each output channel 911-917 may receive select wavelength band or polarization band.

Arrayed waveguide grating 1100 may also be configured as an add/drop module, for example. In this configuration dependence on polarization may provide negligible wavelength dependence in the add/drop stage.

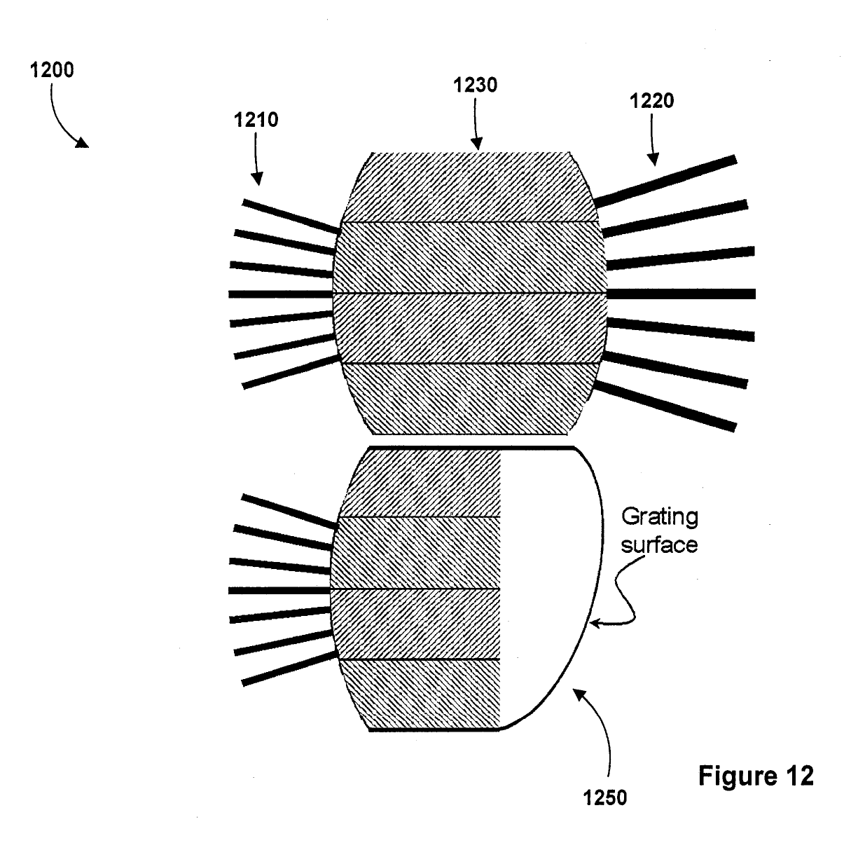

Referring now to FIG. 12, there is shown a configuration of an arrayed waveguide grating 1200 similar to the grating shown in FIG. 11 and discussed hereinabove. As may be seen in FIG. 12, AWG 1200 includes incoming channels 1210 optically coupled to output channels 1220 with state of polarization and control region 1230 optically coupled there between. In this configuration, electromagnetic radiation incident upon AWG 1200 from incoming channels 1210 may be directed by state of polarization and control region 1230 may be directed to one or more of output channels 1220. In an embodiment of AWG 1200 output channels may be replaced with a grating 1250 optically coupled to state of polarization and control region 1230. Grating 1250 operates to couple incident radiation back through region 1230 and output through channels 1210. The grating may operate such that radiation incident upon grating surface from channels 1210 after propagating through state of polarization and control region 1230 may be reflected by grating 1250 through state of polarization and control region 1230 to be output through channels 1210 wherein the output substantially fills a single channel of channels 1210, or alternatively, where the output is substantially equal in each of the channels 1210.

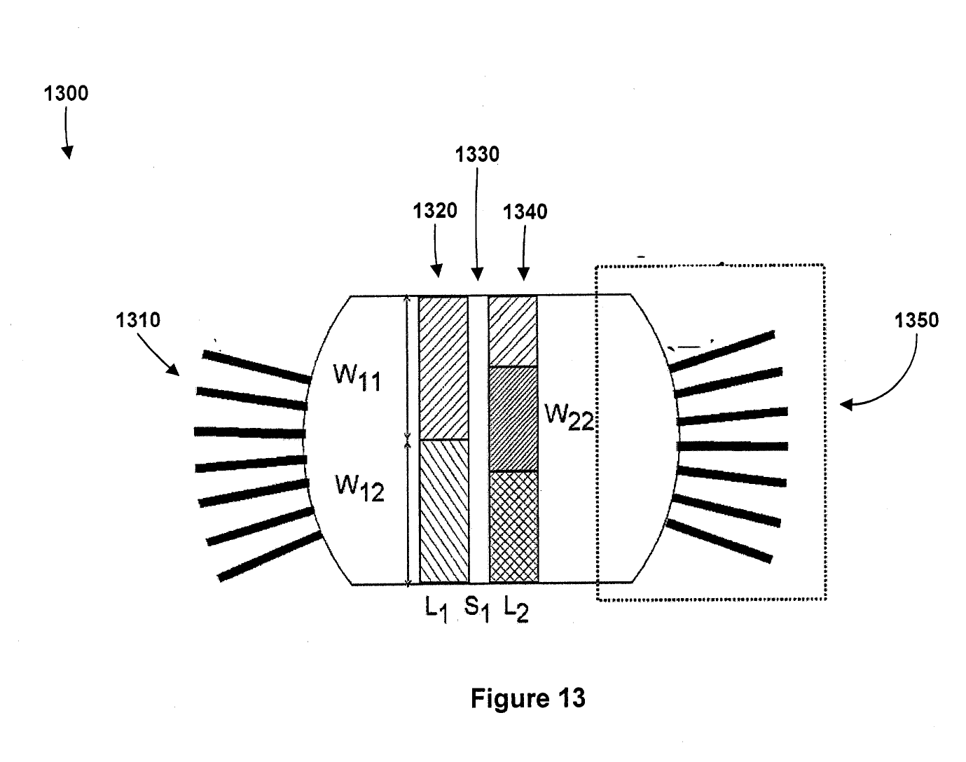

Referring now to FIG. 13, an arrayed waveguide grating 1300 according to an aspect of the present is shown. Arrayed waveguide grating 1300 may be similar conceptually to the arrayed waveguide gratings (1100, 1200) discussed hereinabove with respect to FIG. 11 and 12. As shown in FIG. 13, arrayed waveguide grating 1300 may include an input waveguide core 1310, a first state of polarization and control region 1320, a second state of polarization and control region 1340 separated from the first region 1320 by a space 1330, and an output waveguide core 1350. Space 1330 may be so small as to be negligible in size thereby placing first region 1320 and second region adjacent to each other.

In particular, arrayed waveguide grating may operate to separate polarization states, for example, in incoming waveguide core 1310 and divide incoming polarization states into at least one output waveguide core 1350.

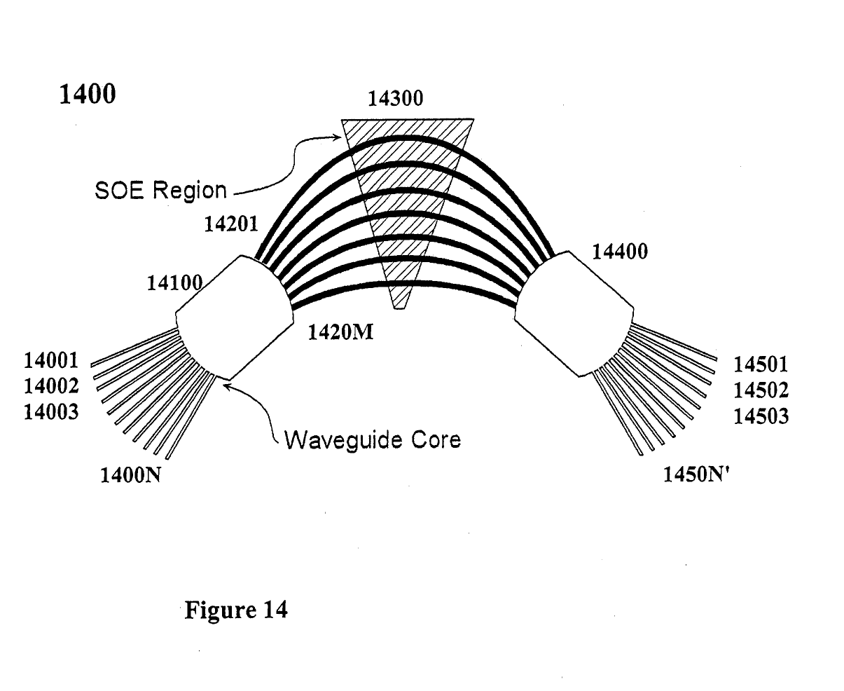

Referring now to FIG. 14, there is shown an arrayed waveguide grating 1400 according to an aspect of the present. Arrayed waveguide grating 1400 may include two star-coupler regions. As shown in FIG. 14, optical signals from one or several channel waveguides 1400.1, 1400.2, 1400.3, . . . , 1400.N may propagate through region 1410.0, and may interfere and redistribute with different strengths and/or polarizations into channels 1420.1, 1420.2, 1420.3, . . . , 1420.M. Polarization states of propagating signals may be effected by index-loaded region of microstructures 1430.0. Signals may interfere in 1440 and may couple into one or more channel waveguides 1450.1, 1450.2, . . . , 1450.N.

Those of ordinary skill in the art will recognize that many modifications and variations of the present invention may be implemented without departing from the spirit or scope of the invention. Thus, it is intended that the present invention covers the modifications and variations of this invention provided they come within the scope of the appended claims and their equivalents.

What is claimed is:

1. A birefringent device suitable for receiving electromagnetic radiation of at least one wavelength, said device comprising:
a waveguiding core suitable for transmitting received electromagnetic radiation; and,
a plurality of nanostructures defining a plurality of alternating regions of differing refractive indices, and positioned with respect to said waveguiding core to effect at least one polarization of the electromagnetic radiation traversing said waveguiding core.

2. The birefringent device of claim 1, wherein said plurality of nanostructures are substantially longitudinally positioned with respect to said waveguiding core.

3. The birefringent device of claim 1, further comprising a layer substantially interpositioned between said plurality of nanostructures and said waveguiding core.

4. The birefringent device of claim 3, wherein said layer comprises an insulator.

5. The birefringent device of claim 3, wherein said layer comprises a semiconductor.

6. The birefringent device of claim 3, wherein said layer comprises a metal.

7. The birefringent device of claim 3, wherein said layer comprises a polymer.

8. The birefringent device of claim 3, wherein said layer is suitable for providing an etch stop.

9. The birefringent device of claim 2, wherein said waveguiding core includes at least one of the group consisting of glass, semiconductors, and polymers.

10. The birefringent device of claim 1, wherein said alternating regions substantially alternate in at least one dimension.

11. The birefringent device of claim 1, wherein said alternating regions substantially alternate in at least two dimensions.

12. The device of claim 1, wherein the period of said alternating regions is approximately in the range of 1 nm to 100 μm.

13. The device of claim 1, wherein the period of said alternating regions is approximately of the range of 1 nm to 1 μm.

14. The device of claim 1, further comprising a first cladding disposed substantially adjacent to said waveguiding core.

15. The device of claim 14, wherein said first cladding comprises an insulator.

16. The device of claim 14, wherein said first cladding comprises a semiconductor.

17. The device of claim 14, wherein said first cladding comprises a metal.

18. The device of claim 14, wherein said first cladding comprises a polymer.

19. The device of claim 14, further comprising a second cladding disposed substantially adjacent said waveguiding core distal to said first cladding.

20. The device of claim 19, wherein said second cladding comprises an insulator.

21. The device of claim 19, wherein said second cladding comprises a semiconductor.

22. The device of claim 19, wherein said second cladding comprises a metal.

23. The device of claim 19, wherein said second cladding comprises a polymer.

24. The device of claim 19, further comprising a central cladding substantially adjacent to said waveguiding core and substantially between said first and second cladding.

25. The device of claim 24, wherein said central cladding comprises an insulator.

26. The device of claim 24, wherein said central cladding comprises a semiconductor.

27. The device of claim 24, wherein said central cladding comprises a metal.

28. The device of claim 24, wherein said central cladding comprises a polymer.

29. The device of claim 24, further comprising a residual layer disposed substantially adjacent to said central cladding.

30. The device of claim 29, wherein said residual layer comprises an insulator.

31. The device of claim 29, wherein said residual layer comprises a semiconductor.

32. The device of claim 29, wherein said residual layer comprises a metal.

33. The device of claim 29, wherein said residual layer comprises a polymer.

34. The device of claim 29, wherein said plurality of nanostructures are disposed substantially within said first cladding.

35. The device of claim 29, wherein said plurality of nanostructures are disposed substantially within said second cladding.

36. The device of claim 29, wherein said plurality of nanostructures are disposed substantially within said central cladding.

37. The device of claim 29, wherein said central cladding separates a portion of said waveguiding core into at least a first and second leg.

38. The device of claim 37, wherein said plurality of nanostructures substantially effect substantially one polarization state of the electromagnetic radiation traversing said first leg.

39. The device of claim 38, wherein said plurality of nanostructures substantially effect a substantially orthogonal polarization state of the electromagnetic radiation to said effected polarization of said first leg traversing said second leg.

40. The device of claim 39, further comprising signal processing of the electromagnetic radiation traversing at least one of said first or second leg.

41. The device of claim 40, wherein said signal processing includes at least one electrode strip substantially adjacent to said waveguiding core.

42. The device of claim 40, wherein said signal processing includes at least one heater strip substantially adjacent to said waveguiding core.

43. The device of claim 40, wherein said signal processing includes at least one magnetic strip substantially adjacent to said waveguiding core.

44. The device of claim 40, wherein said signal processing includes using at least one light beam substantially adjacent to said waveguiding core.

45. The device of claim 40, further comprising a rotator disposed in at least one of said first or second legs of said waveguiding core suitable for rotating the polarization traversing said rotator.

46. The device of claim 45, further comprising a junction joining at least said first and second leg of said waveguiding core.

47. The birefringent device of claim 1, further comprising an input region optically coupled to said waveguiding core and an output region optically coupled to said waveguiding core optically distal to said input region.

48. The birefringent device of claim 47, further comprising at least one input channel optically coupled to said input region.

49. The birefringent device of claim 48, further comprising at least one output channel optically coupled to said output region.

50. The birefringent device of claim 49, further comprising at least a second waveguiding core suitable for transmitting the electromagnetic radiation optically coupled to said input and said output regions; and, at least a second plurality of nanostructures sized smaller than the at least one wavelength and defining a plurality of alternating regions of differing refractive indices, and positioned with respect to said second waveguiding core to effect the polarization of the electromagnetic radiation traversing said second waveguiding core.

51. The birefringent device of claim 50, wherein said waveguiding core and said second waveguiding core are substantially identical.

52. The birefringent device of claim 50, wherein said first plurality of nanostructures and said second plurality of nanostructures are substantially identical.

53. The birefringent device of claim 50, wherein said electromagnetic radiation traversing said at least one input channel is substantially coupled to said at least one output channel after substantially traversing said input region, said waveguide core, and said output region.

54. The birefringent device of claim 53, wherein said device is suitable for at least one of wavelength division multiplexing, wavelength division demultiplexing, wavelength filtering, add/drop filtering, and switching.

55. The birefringent device of claim 48, further comprising a grating optically coupled to said output region.

56. The birefringent device of claim 53, wherein said grating substantially reflects said electromagnetic radiation traversing said waveguiding core coupling said reflect electromagnetic radiation through said at least one input channel.

57. A birefringent device suitable for receiving electromagnetic radiation of at least one wavelength, said device comprising:
a waveguiding core suitable for transmitting the electromagnetic radiation;
a plurality of nanostructures sized smaller than the at least one wavelength and defining a plurality of alternating regions of differing refractive indices, and positioned with respect to said waveguiding core to effect the polarization of the electromagnetic radiation traversing said waveguiding core;
a first cladding disposed substantially adjacent to said waveguiding core;
a second cladding disposed substantially adjacent said waveguiding core distal to said first cladding; and,
a central cladding substantially adjacent to said waveguiding core and substantially between said first and second cladding.

58. The device of claim 57, wherein said plurality of nanostructures are disposed substantially within said first cladding.

59. The device of claim 57, wherein said plurality of nanostructures are disposed substantially within said second cladding.

60. The device of claim 57, wherein said plurality of nanostructures are disposed substantially within said central cladding.

61. A birefringent device suitable for receiving electromagnetic radiation of at least one wavelength, said device comprising:
a waveguiding core suitable for transmitting the electromagnetic radiation including at least a first and second portion; and,
a plurality of nanostructures sized smaller than the at least one wavelength and defining a plurality of alternating regions of differing refractive indices, and positioned with respect to said waveguiding core to effect the polarization of the electromagnetic radiation traversing said waveguiding core,
wherein said plurality of nanostructures substantially effect substantially one polarization state of the electromagnetic radiation traversing said first portion, and
wherein said plurality of nanostructures substantially effect a substantially orthogonal polarization state of the electromagnetic radiation to said effected polarization of said first leg traversing said second portion.

62. A birefringent device suitable for receiving electromagnetic radiation of at least one wavelength, said device comprising:
a waveguiding core suitable for transmitting the electromagnetic radiation including at least a first and second portion;
a plurality of nanostructures sized smaller than the at least one wavelength and defining a plurality of alternating regions of differing refractive indices, and positioned with respect to said waveguiding core to effect the polarization of the electromagnetic radiation traversing said waveguiding core;
an input region optically coupled to said waveguiding core;
an output region optically coupled to said waveguiding core optically distal to said input region;
at least one input channel optically coupled to said input region; and,
at least one output channel optically coupled to said output region.

63. The birefringent device of claim 62, further comprising at least a second waveguiding core suitable for transmitting the electromagnetic radiation disposed optically coupled to said input and said output regions; and, at least a second plurality of nanostructures sized smaller than the at least one wavelength and defining a plurality of alternating regions of differing refractive indices, and positioned with respect to said second waveguiding core to effect the polarization of the electromagnetic radiation traversing said second waveguiding core.

64. A birefringent device suitable for receiving electromagnetic radiation of at least one wavelength, said device comprising:
a waveguiding core suitable for transmitting the electromagnetic radiation;
a plurality of nanostructures defining a plurality of alternating regions of differing refractive indices, and positioned with respect to said waveguiding core to effect the polarization of the electromagnetic radiation traversing said waveguiding core;
at least one input channel optically coupled to said waveguiding core; and,
at least one output channel optically coupled to said waveguiding core distal to said at least one input channel.

65. A birefringent device suitable for receiving electromagnetic radiation of at least one wavelength, said device comprising:
a waveguiding core suitable for transmitting the electromagnetic radiation;
a plurality of nanostructures defining a plurality of alternating regions of differing refractive indices, and positioned with respect to said waveguiding core to effect the polarization of the electromagnetic radiation traversing said waveguiding core;
at least one input channel optically coupled to said waveguiding core; and,
a grating optically coupled to said waveguiding core distal to said at least one input channel,
wherein said grating substantially reflects said electromagnetic radiation traversing said waveguiding core coupling said reflect electromagnetic radiation through said at least one input channel.

66. A method for producing a birefringent device suitable for receiving electromagnetic radiation of at least one wavelength, said method comprising:
selecting a waveguide, including a waveguiding core;
planarizing said waveguide;
forming a plurality of nanostructures defining a plurality of alternating regions of differing refractive indices, and positioned with respect to said waveguiding core to effect the polarization of the electromagnetic radiation traversing said waveguiding core; and,
disposing a cladding material substantially adjacent to said plurality of nanostructures.

67. The method of claim 66, wherein said waveguide includes at least one of bottom cladding and central cladding.

68. The method of claim 66, wherein said planarizing includes depositing a thin film suitable as buffer between said plurality and said waveguiding core.

69. The method of claim 66, wherein said forming is performed by at least one of nanoimprinting lithography, e-beam direct writing, holography, laser writing, direct molding, or near-field optical coupling methods.

70. A method for producing a birefringent device suitable for receiving electromagnetic radiation of at least one wavelength, said method comprising:
forming a bottom cladding;
forming a plurality of nanostructures defining a plurality of alternating regions of differing refractive indices, and positioned with respect to a waveguiding core to effect the polarization of the electromagnetic radiation traversing said waveguiding core;
depositing said waveguiding core in form of the thin films; and,
depositing a cladding onto the microstructures which forms at least a central cladding or top cladding.

71. The method of claim 70, wherein said forming a plurality is performed by at least one of nanoimprinting lithography, e-beam direct writing, holography, laser writing, direct molding, or near-field optical coupling methods.

72. The method of claim 70, wherein said plurality is formed substantially on the top of said bottom cladding.

73. The method of claim 70, wherein said plurality is formed at least partially inside said bottom cladding.

74. The method of claim 70, wherein said depositing said waveguiding core forms said waveguiding core as planar guides.

75. The method of claim 70, wherein said depositing said waveguiding core forms said waveguiding core as channel guides.

76. The method of claim 70, wherein said depositing said waveguiding core forms said waveguiding core as a combination of planar and channel guides.

77. The method of claim 70, further comprising depositing a thin film suitable as buffer between said plurality and said waveguiding core.

78. A method for producing a birefringent device suitable for receiving electromagnetic radiation of at least one wavelength, said method comprising:
selecting a substrate including a waveguiding core;
depositing at least one layer suitable for subsequent etching;
depositing a photoresist;
forming a plurality of nanostructures defining a plurality of alternating regions of differing refractive indices in said photoresist, and positioned with respect to said waveguiding core to effect the polarization of the electromagnetic radiation traversing said waveguiding core;
transferring said plurality of nanostructures into said at least one layer; and,
planarizing said transferred plurality of nanostructures.

79. The method of claim 78, wherein said substrate includes at least one of glass, fused silica, semiconductor, or polymeric films.

80. The method of claim 78, wherein said depositing photoresist provides a thickness of photoresist in the range of approximately 1 to 1000 nm.

81. The method of claim 78, wherein said plurality of nanostructures is substantially one-dimensional.

82. The method of claim 78, wherein said plurality of nanostructures is substantially two-dimensional.

83. The method of claim 78, wherein said plurality of nanostructures is substantially periodic.

84. The method of claim 78, wherein said plurality of nanostructures is substantially non periodic.

85. The method of claim 78, wherein said transferring said plurality includes at least one of chemical solutions, dry etching, or wet etching.

86. The method of claim 78, further comprising aligning said waveguiding core relative to said plurality of nanostructures.
